(19) United States
(12) Patent Application Publication
(10) Pub. No.: US 2016/0104251 A1
(43) Pub. Date: Apr. 14, 2016

(54) METHOD AND SYSTEM FOR MOBILE COMMERCE WITH REAL-TIME PURCHASE SUPPORT

(71) Applicants: Gyan Prakash, Beaverton, OR (US); Shahrokh Shahidzadeh, Portland, OR (US)

(72) Inventors: Gyan Prakash, Beaverton, OR (US); Shahrokh Shahidzadeh, Portland, OR (US)

(21) Appl. No.: 14/881,125

(22) Filed: Oct. 12, 2015

Related U.S. Application Data
(63) Continuation of application No. 13/997,753, filed on Jun. 25, 2013.

(51) Int. Cl. G06Q 40/00; G06Q 20/20; G06Q 20/32; G06Q 20/36

(52) U.S. Cl. CPC G06Q 40/12; G06Q 20/36; G06Q 20/202; G06Q 20/327

(57) ABSTRACT

A method and system provides the user of a computing device with information, analysis, suggestions and/or recommendations relating to the user's financial information and/or purchasing history, in relation to an electronic commerce transaction initiated by the user at the computing device, prior to, during, or after completion of the electronic commerce transaction.

### CROSS-REFERENCE TO RELATED APPLICATIONS

This application is a continuation application of U.S. application Ser. No. 13/997,753, entitled “Method and System for Mobile Commerce with Real-Time Purchase Support,” which was filed on Jun. 25, 2013 and which is a national stage entry under 35 USC §371(b) of International Application No. PCT/US2011/067800, which was filed on Dec. 29, 2011.

### BACKGROUND

Computing devices, and mobile computing devices in particular, are increasingly used to conduct commerce. In electronic commerce (“e-commerce”) transactions, payments for products and/or services are tendered electronically, that is, without the need to present physical currency (e.g., coins, bills, personal checks, etc.), credit or debit cards, or the like. To effectuate an e-commerce transaction, a purchaser provides his or her payment information (e.g. payment type, account number, authorization code, etc.) to a vendor via an electronic transmission generated by a computing device. In some cases, the purchaser's payment information is manually entered (e.g. into a digital form on the vendor's web site). However, some purchasers may opt to store their payment information in memory of a computing device, so that it does not have to be manually entered each time the user desires to make a purchase.

A digital wallet or “e-wallet” is a term that may be used to describe a user's payment information, which may include account information for multiple different payment methods, when it is stored on a computing device for use in conducting e-commerce. This term may also be used to refer to an electronic device that embodies such information. Increasingly, digital wallet technology is being applied to mobile computing devices, such that purchasers can make purchases simply by presenting their mobile computing device at a point of sale.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for conducting electronic commerce transactions;

FIG. 2 is a simplified module diagram for at least one embodiment of a purchase support system usable in connection with the system of FIG. 1;

FIG. 3 is a simplified data model diagram for at least one embodiment of the purchase support system of FIG. 1; and

FIG. 4 is a simplified flow diagram of at least one embodiment of a method of providing purchase support in an electronic commerce transaction.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the scope of the invention, as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more link (e.g. bus)-based interconnects between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in, a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages.

Similarly, schematic elements used to represent data or information may implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. Also, for ease of illustration a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

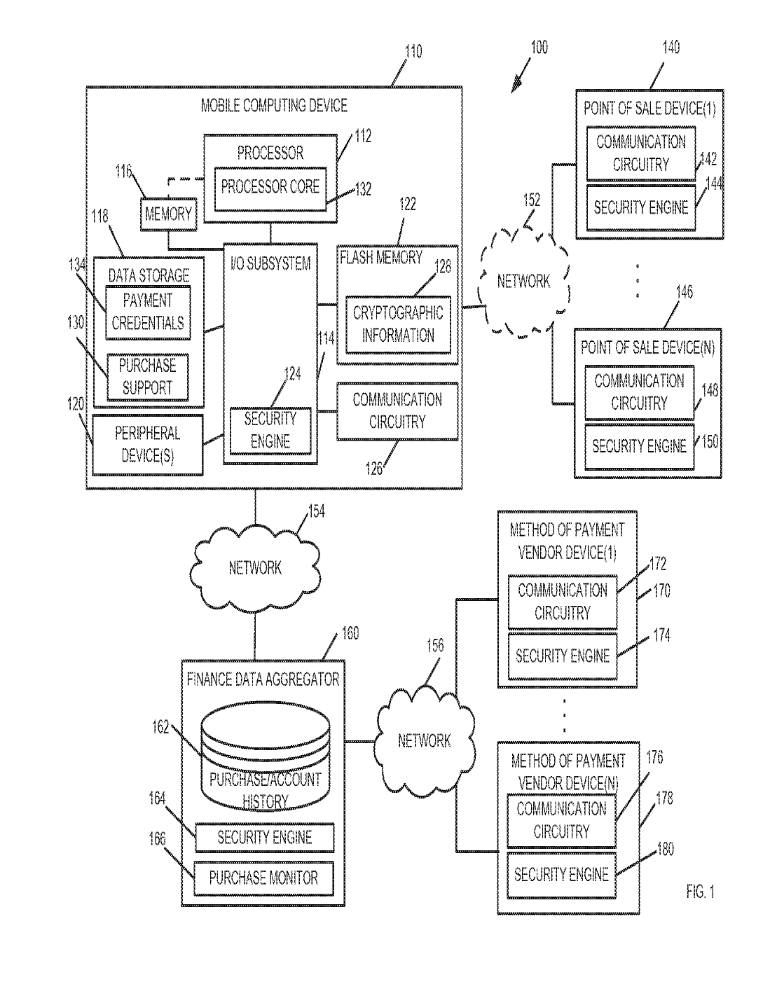

Referring now to FIG. 1 an illustrative system 100 for conducting electronic commerce transactions includes a mobile computing device 110. The mobile computing device 110 can transmit payment information to a point of sale device 140, 146 associated with a vendor of a product or service desired to be purchased by the user of the mobile computing device 110. The system 100 also includes a purchase support system 130, which is embodied as a computerized application that is embodied in the mobile computing device 110. In operation, features of the purchase support system 130 are executed in real time when the user of the mobile computing device 110 initiates an electronic commerce transaction (e.g., a purchase of a product or service) at the mobile computing device 110.

As described in more detail below, the purchase support system 130 interfaces with a finance data aggregator 160 to, during an electronic commerce transaction initiated by the user of the mobile computing device 110, provide the user with an up-to-date report of the user's financial information, analysis and/or advice (e.g., suggestions, recommendations, etc.) as to which of several payment methods available to the user may provide the most favorable outcome for the user, based on details of the initiated electronic commerce transaction, information relating to payment methods, the user's personal financial information and/or purchase history, and/or other pertinent information available to the mobile computing device 110. The finance data aggregator 160 interfaces with one or more method of payment vendor devices 170, 178, responsively, periodically, or continuously (e.g. via one or more background processes), to collect and maintain the user's financial information, results of analysis, and information relating to the user's history of electronic commerce transactions.

The mobile computing device 110 may be embodied in or as any type of mobile computing device capable of performing the functions described herein. For example, the mobile computing device 110 may be embodied as a cellular phone, a smart phone, a mobile Internet device, a handheld, laptop or tablet computer, a personal digital assistant, a telephony device, or other portable electronic device. While not typically considered “mobile” in so far as that term may be inferred by some as referring to a handheld device, it should be understood that aspects of this disclosure are applicable to other types of electronic devices, such as a desktop computer, a server, an enterprise computer system, a network of computers, an Internet-enabled television, or other electronic device that is capable of effectuating electronic commerce transactions (e.g., via a vendor's Internet web site), depending on the particular implementation of the system 100.

The illustrative mobile computing device 110 includes at least one processor 112, a memory 116, an input/output (I/O) subsystem 114, a storage device 118, one or more peripheral devices 120, a flash memory 122, and communication circuitry 126. One or more of the foregoing components may be incorporated on a motherboard or the mobile computing device 110 while other components be communicatively coupled to the motherboard via, for example, a peripheral port.

In some embodiments, the I/O subsystem 114 may include a security engine 124. The security engine 124 generally includes computerized logic configured to perform security, encryption, and/or authentication functions. The security engine 124 may be embodied as hardware, software, firmware, and/or a combination thereof. For example, the security engine 124 may be embodied as or include a trusted platform module (TPM) and/or other security enhancing hardware and or associated software or firmware modules. The security engine 124 interfaces with one or more corresponding security engines 144, 150, 164, 174, 180 of the point of sale devices 140, 146, finance data aggregator 160, and payment vendor devices 170, 178, respectively, to effectuate secure transmission of the user's personal payment and financial information over network(s) 152, 154, 156 and among the various devices 110, 140, 146, 160, 170, 178, as needed by the purchase support, system 130 or otherwise, to provide finance information and/or suggestions to the user and/or accomplish electronic commerce transactions in the system 100.

In general, the security engine 124 uses cryptographic information 128 to encrypt digital messages that include the user's personal financial and/or payment information, such as payment credentials 134. The cryptographic information 128 may include a private key or other security mechanism usable by the security engine 124. The payment credentials 134 may include, for example, one or more bank and/or credit card account numbers, authorization codes, and/or other similar or related information usable to effectuate payment in an electronic commerce transaction. The payment credentials 134 may be stored as a digital wallet and/or managed by a digital wallet application.

The cryptographic information 128 and payment credentials 134 are stored in memory of the mobile computing device 110, and the purchase support system 130 is installed on the mobile computing device 110. In the illustrative embodiment, the cryptographic information 128 is stored in the flash memory 122, which is non-volatile, while the purchase support system 130 and the payment credentials 134 reside in the storage device 118. In other embodiments, all or other portions of the cryptographic information 128, the purchase support system 130, and/or payment credentials 134 may reside in other locations accessible to the processor 112. For example, portions of the cryptographic information 128, purchase support system 130, and/or payment credentials 134 may be loaded into the memory 116 during operation of the mobile computing device 110, for faster processing or other reasons.

The illustrative processor 112 may be embodied as one or more processor cores or logical sections of a single core 132. In addition to cache memory, the processor 112 and/or its core(s) include, or are otherwise communicatively coupled to, the memory 116. Portions of the memory 115 may be embodied as any type of suitable memory device, such as a dynamic random access memory device (DRAM), synchronous dynamic random access memory device (SDRAM), double-data rate dynamic random access memory device (DDR SDRAM) and/or other volatile memory devices. Although a single memory device 116 is illustrated in FIG. 1, in other embodiments, the mobile computing device 110 may include additional (e.g., logical or physical) memory devices. Various data and/or computer instructions, such as operating systems, applications, programs, libraries and drivers executable by the processor 112, may reside in the memory 116 during operation of the system 100.

The processor 112 is also communicatively coupled to the I/O subsystem 114. Although not specifically shown, the I/O ubsystem 114 typically includes a memory controller (e.g., a memory controller hub (MCH) or northbridge), an input/output controller (e.g., an input/output controller hub (ICH) or southbridge), and a firmware device (e.g., BIOS or UEFI). Of course, in other embodiments, I/O subsystems having other configurations may be used. For example, in some embodiments, the I/O subsystem 114 may form a portion of a system-on-a-chip (SoC) and be incorporated, along with the processor 112 and other components of the mobile computing device 110, on a single integrated circuit chip. As such, it will be appreciated that each component of the I/O subsystem 114 may be located on a common integrated circuit chip in some embodiments.

The I/O subsystem 114 is communicatively coupled to the storage device 118. Portions of the storage 118 may be embodied as any suitable device for storing data and/or computer instructions, such as disk storage (e.g. hard disks), memory cards, memory sticks, and/or others. In addition to the purchase support system 130 and the payment credentials 134, one or more operating systems, application programs and/or data structures may be embodied in the storage 118, in some embodiments.

The I/O subsystem 114 may be communicatively coupled to one or more peripheral and/or interface devices 120. The peripheral device(s) 120 may include one or more network interfaces, graphics and/or video adaptors, keyboards, keypads, touchscreens, displays, printers, data storage devices, a computer mouse, and/or other peripheral devices, depending upon, for example, the intended use of the mobile computing device 110. Further, it should be appreciated that the mobile computing device 110 may include other components, sub-components, and devices not illustrated in FIG. 1 for clarity of the description.

The communication circuitry 126 of the mobile computing device 110 may be embodied as one or more devices and/or circuitry configured to enable communications between the mobile computing device 110, the point of sale devices 140, 146, the finance data aggregator 160, and/or the payment vendor devices 170, 178 via the one or more networks 152, 154, 156. The communication circuitry 126 is communicatively coupled to the I/O subsystem 114, and, may include one or more wired and/or wireless network interfaces to facilitate communications over the wired and/or wireless portions of the networks) 152, 154, 156. In some embodiments, the communication circuitry 126 may include Near Field Communications (NFC) circuitry, which may be embodied as relatively short ranged (e.g., a few inches or centimeters), high frequency wireless communication circuitry, and may be incorporated in circuitry of the communication circuitry 126 or separate therefrom. For example, in some embodiments, the effective communication range of the NEC circuitry is no greater than about ten centimeters. The relatively short communication range of the NFC circuitry allows validation of the physical presence of another communication device e.g., a point of sale device 140, 146) when using the NFC circuitry to communicate. Additionally, the NFC circuitry allows the mobile computing device 110 to conduct wireless, contactless communication with one or more of the point of sale devices 140, 146 and/or other contactless communication-enabled devices. For example, in some embodiments, payment credentials 134 may be securely transmitted from the mobile computing device 110 to a point of sale device 140, 146 to complete an electronic commerce transaction, simply by tapping or holding the mobile computing device 110 near the point of sale device 140, 146.

The one or more networks 152, 154, 156 may be embodied as any type of wired and/or wireless telecommunication networks. For example, one or more of the networks 152, 154, 156 may be embodied as or otherwise include one err more public or private cellular networks, telephone, Digital Subscriber Line (DSL) or cable networks, local or wide area networks, publicly available global networks (e.g., the Internet), or any combination thereof. For example, in some embodiments, one or more of the networks 152, 154, 156 is embodied as or otherwise includes a Global System for Mobile Communications (GSM) cellular network. Additionally, the networks 152, 154, 156 may include any number of additional devices as needed to facilitate communication between or among the mobile computing device 110 and the point of sale devices 140, 146, finance data aggregator 160 and method of payment vendor devices 170, 178, such as routers, switches, intervening computers and/or others. Any suitable communication protocol (e.g. TCP/IP) may be used to effectuate communication over the networks 152, 154, 156 depending on, for example, the particular type or configuration of the networks 152, 154, 156. In some embodiments, at least the network 152 is embodied not as a network in the traditional sense, but as a wireless, contactless communication medium configured to enable Near Field Communication or other short range wireless communications (e.g., NFC circuitry).

The finance data aggregator 160 the one or more point of sale devices 140, 146, and the one or more method of payment vendor devices 170, 178, are, in the illustrative embodiment, computing devices. While details of the specific structure of the finance data aggregator 160, the one or more point of sale devices 140, 146, and the one or more method of payment vendor devices 170, 178 have been omitted so as not to obscure the disclosure, it should be understood that each of these devices generally includes one or more processors, memory, an I/O subsystem, communication circuitry and a security engine similar or analogous to those shown and described above in connection with the mobile computing device 110.

The illustrative finance data aggregator 160 is communicatively coupled to the mobile computing device 110 via the network 154, which may be part of or separate from the network 152 and/or the network 156. In some embodiments, the finance data aggregator 160 is a cloud-based data aggregating computing device or service, which may include one or more servers, networks of servers, enterprise systems, or the like. As mentioned above, the finance data aggregator 160 collects and maintains the user's financial and purchase-related data in the database 162, which is stored in memory at the finance data aggregator 160. The user's financial and, purchase-related data is received periodically or continuously by the finance data aggregator 160 from, the one or more method of payment vendor devices 170, 178, and/or other electronic devices, using, e.g., a “push” method of obtaining data, in which the one or more method of payment vendor devices 170, 178 transmits the user's data to the finance data aggregator 160 without prompting by the finance data aggregator 160 (e.g., on a daily or weekly basis or as electronic commerce transactions are completed by the user); or a “pull” method of obtaining data, in which the one or more method of payment vendor devices 170, 178 transmits the user's data, to the finance data aggregator 160 in response to prompting by the finance data aggregator 160. The finance data aggregator 160 may be operated or maintained by or on behalf of a financial services company or a third-party computing services provider, for example.

The database 162 may be embodied as one or more databases and/or other physical or logical data structures, and may reside on one or more physical or logical storage devices of or associated with the finance data aggregator 160. In general, the data collected and maintained in the database 162 can include any or all of the user's financial and/or purchase-related information, depending on the configuration of the system 100. In the illustrative embodiments, the database 162 is configured to store and maintain all finance and purchase-related data of the user (alone or in addition to that of other users), for all methods of payment used by the user in all of the user's electronic commerce transactions in which electronic records are kept. For example, the database 162 includes the user's finance and purchase-related data for all credit cards, debit cards, and other payment cards (e.g., gift cards, prepaid cards, etc.), electronic payment or billing services (e.g. Paypal), electronic banking services, and the like, that are used by the user, whether the transaction is conducted in-person at a physical vendor site, on the mobile computing device 110, or using, another computing device (e.g. a home PC or a smart TV). Some illustrative types of information collected and maintained by the database 162 include, for example, the user's bank and credit card account numbers and balances; products and/or services purchased, rented, or leased and the corresponding price and payment terms; outstanding loans and mortgages, current loan and mortgage balances and repayment terms, monthly payment amounts, and/or others. In some embodiments, the results of one or more analyses performed by the purchase support system 130, described below, may be stored in the database 162, as well.

The illustrative finance data aggregator 160 also includes a purchase monitor 166. The purchase monitor 166 is embodied as a computerized application stored in memory at the finance data aggregator 160. The purchase monitor 166 continuously monitors the database 162 for irregular or inconsistent patterns of financial or purchasing activity associated with the user (e.g., a payment significantly larger than all other payments made to a particular vendor). If an irregular or inconsistent pattern of activity is detected by the purchase monitor 166, the purchase monitor 166 transmits an alert to the purchase support system 130 at the mobile computing device 110. The purchase support system 130 is configured to process the alert and display and/or annunciate (e.g., using a visual and/or audible signal) the alert at the mobile computing device 110. In this way, the purchase and support system 130 can operate as a mobile device-based identity theft and/or fraud alert system.

The finance data aggregator 160 is communicatively coupled to the one or more method of payment vendor devices (e.g., method of payment vendor device(1) 170 to method of payment vendor device(n) 178, where n is a positive integer) via the network 156, which may be part of or separate from the network 152 and/or the network 154. In general, the method of payment vendor devices 170, 178 are embodied as computing devices or networks of computing devices that handle financial and/or payment transactions for method of payment vendors such as banks, credit card companies, lenders, online payment services, and/or digital wallet services such as Google Wallet and ISIS™. As such, the method of payment vendor devices 170, 178 collect financial and/or purchase information as the user engages in financial activity and/or conducts electronic commerce transactions. As noted above, the method of payment vendor devices 170, 178 include communication circuitry 172, 176 and security engines 174, 180, which enable the method of payment vendor devices 170, 178 to securely transmit the user's financial and/or electronic commerce transaction data over the network 156 to the finance data aggregator 160 and/or other devices. While not explicitly shown, it should be understood that, once the user has approved payment in an electronic commerce transaction, the method of payment vendor devices 170, 178 interface as needed (e.g., network 152, 154, 156) with one or more of the point of sale devices 140, 146 to validate or authorize payment and complete the electronic commerce transaction between the user and the products and/or services vendor associated with the one or more point of sale devices 140, 146.

The one or more point of sale devices (e.g., point of sale device(1) 140 to point of sale device(n) 146, where n is a positive integer) are communicatively coupled to at least the mobile computing device 110 via the network 152, which may be part of or separate from the network 154 and/or the network 156. In general, the point of sale devices 140, 146 are embodied as imputing devices or networks of computing devices that handle electronic commerce transactions for products and/or services vendors such as retailers, wholesalers, third-party facilitators (such as eBay and Amazon.com), and service providers. In some cases, the products and/or services vendor may be the same as the method of payment vendor (e.g., when a products and/or services vendor offers its own credit card).

The point of sale devices 140, 146 receive method of payment information and other details relating to products and/or services involved in an electronic commerce transaction initiated by the user, when the user initiates the electronic commerce transaction at the mobile computing device 110. As noted above, the point of sale devices 140, 146 include communication circuitry 142, 148 and security engines 144, 150, which enable the point of sale devices 140, 146 to securely transmit the user's method of payment information to the appropriate method of payment vendor for validation or authorization. If the user's method of payment is approved by the method of payment vendor, the point of sale computing device 140. 146 completes the electronic transaction and delivers or schedules delivery of the purchased products and/or services to the user, as the case may be.

In some embodiments, the point of sale device 140, 146 is embodied, as an electronic device (e.g., a desktop or portable computer or credit card scanner) operated by a vendor at a physical location (e.g., a checkout counter) of the vendor. In these embodiments, the point of sale device 140, 146 may include NFC circuitry configured to communicate with NFC circuitry of the mobile computing device 110, so that the user's method of payment information may be transmitted directly from the mobile computing, device 110 to the point of sale device 140, 146 using the short range NFC technology. In other embodiments, the point of sale device 140, 146 may be embodied as software executable by a products and/or services vendor via the vendor's Internet web site or another online application. In these embodiments, the user's method of payment information may be specified at the mobile computing device 110 and transmitted to the point of sale device 140, 146 via a network 152, 154, 156. In any case, the user's method of payment information (e.g., payment credentials 134) may be embodied in a digital wallet, which may be embodied in the mobile computing device 110 or another device (e.g., a secure third-party server), and the mobile computing device 110 may be configured to access the digital wallet, select a method of payment, and authorize the sending of the method of payment information to the point of sale device 140, 146.

In general, the components of the mobile computing device 110, the finance data aggregator 160, the one or more point of sale devices 140, 146, the one or more method of payment vendor devices 170, 178, and the system 100 are communicatively coupled as shown in FIG. 1, by one or more signal paths, which are represented schematically as double-headed arrows. Such signal paths may be embodied as any type of wired or wireless signal paths capable of facilitating communication between the respective devices. For example, the signal paths may be embodied as any number of wires, links, printed circuit board traces, via, bus, point-to-point interconnects, intervening devices, and/or the like.

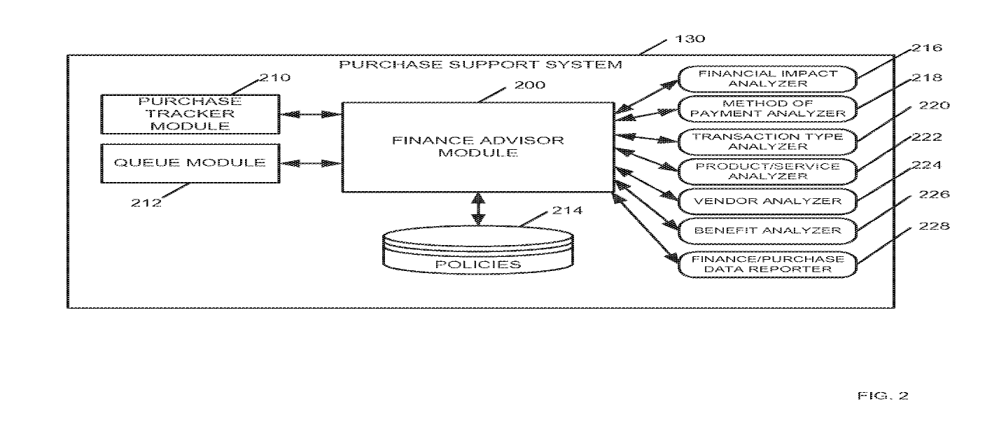

Referring now to FIG. 2, computerized modules of the illustrative purchase support system 130, embodied on the mobile computing device 110, are shown. A finance advisor module 200 is communicatively coupled to a purchase tracker module 10, a queue module 212, a policies database 214, and one or more analyzer modules, which may include a financial impact analyzer 216, a method of payment analyzer 218, a transaction type analyzer 220, a product/service analyzer 222, a vendor analyzer 224, a benefit analyzer 226, and a finance/purchase data reporter 228.

The purchase tracker module 210 is embodied as computerized logic that is configured to, once launched, execute continuously (e.g., as a background process) to determine when the user initiates an electronic commerce transaction at the mobile computing device 110. The purchase tracker module 210 may be embodied as, for example, a plug-in for a web browser or a mobile application (“app”) launchable from a display or touchscreen of the mobile computing device 110. In some embodiments, the purchase tracker module 210 determines when the user has initiated an electronic commerce transaction and when the electronic commerce transaction has been completed. Some examples of “triggers” that may be used by the purchase tracker module 210 to determine when an electronic commerce transaction has been initiated or completed include detecting when the user has added a good or service to a “shopping cart” in a graphical user interface of a vendor's online application and detecting when the use has selected a “check out,” “buy now,” “confirm purchase?” or similar button (or touchscreen control), or has accepted the vendor's online terms and conditions (e.g., by clicking or touching a radio button or check box) in a graphical user interface of a vendor's online application. In some embodiments, in which the user's method of payment information is stored at the mobile computing device 110 (e.g., in a digital wallet), accessing the method of payment information or digital wallet may act as a trigger used by the purchase tracker module 210 to determine when, an electrode transaction has been initiated or completed. In response to determining that an electronic commerce transaction has been initiated or completed by the user at the mobile computing device 110, the purchase tracker module 210 launches the finance advisor module 200.

The queue module 212 is embodied as computerized logic that, when launched, executes continuously (e.g., as a background process) to monitor, for a user-specified period of time, network activity relating to the pricing of one or more products and/or services desired to be purchased by the user. More specifically, the queue module 212 monitors the prices supplied by one or more vendors of the desired good and/or service (e.g., by “crawling” the Internet and/or specific areas of the Internet devoted to pricing information, such as Google Shopper, Price Check, and/or Price Grabber). The queue module 212 is an optional feature that may or may not be activated by the user of the mobile computing device 110. When active, the queue module 212 is configured to alert the user of the mobile computing device 110 when a vendor's price for the desired good and/or service matches or comes within a specified range of a price specified by the user (e.g. using a touchscreen, microphone, or other input device coupled to the mobile computing device 110). In some embodiments, the queue module 212 may maintain (e.g., in memory of the mobile computing device 110), a “wish list” of products or services desired by the user and the price at which the user is willing to purchase each such product or service. If a vendor's price for a desired product or service matches the user's specified price or is within the user's specified price range, the queue module 212 outputs a message to the user (via, e.g., a display screen or speaker of the mobile computing device 110) suggesting that the user initiate an electronic commerce transaction to purchase the good and/or service, if the user responds affirmatively to the message, then the queue module 212 may launch the finance advisor module 212 or may proceed directly to the vendor's online purchase application to allow the user to purchase the desired good and/or service. If the user-specified period of time expires without a vendor meeting the user's price requirements for a particular desired product or service, the queue module 212 discontinues the price monitoring for that product or service.

The finance advisor module 200 is embodied as computerized logic configured to, when launched, provide the user of the mobile computing device 110 with real-time transaction-based financial information, analysis, and/or suggestions at the point of sale. In some embodiments, the finance advisor module 200 may be embodied as, for example, a plug-in for a web browser or an application launchable from a display or touchscreen of the mobile computing device 110. As noted above, the finance advisor module 200 is executed (e.g. launched by the purchase tracker module 210 or the queue module 212) whenever any electronic commerce transaction is initiated or completed using the mobile computing device 110. The finance advisor module 200 interfaces with the finance data aggregator 160 and with one or more user-definable policies, which may be stored in a database 214; and executes one or more of the analysers 216, 218, 220, 222, 224, 226, 228 as may be requested by the user (using, e.g., a touchscreen, microphone, or other input device coupled to the mobile computing device 110, to provide financial information, analysis, and/or suggestions to the user during an electronic commerce transaction.

Interfacing, with the finance data aggregator 160, the finance advisor module 200 maintains, in memory of the computing device 110, a history of the user's recent electronic commerce transactions (e.g. a history of all purchases made by the user in the last 30 days). In some embodiments, the finance advisor module 200 may interface with the finance data aggregator 160 in real time (e.g., via the network 154). In other embodiments, a cached copy of a portion of the data stored at the finance data aggregator 160 can be maintained at the mobile computing device 110, so that in the absence of network connectivity, or for other reasons, the finance advisor module 200 can access at least a subset of the purchase or account history data 162 and use it to provide purchasing feedback and/or finance-related advice to the user. For example, in some embodiments, a subset of the user's most recent purchase and/or financial data may be, cached in memory of the mobile computing device 110. Some examples of locally cached data may include the user's purchase history for the last 25-50 days, or the user's history of high value purchases (e.g. purchases exceeding a certain dollar amount during the last 6 months). The time period, transaction type, and/or other parameters for maintaining the user's purchase history may be configurable by the user.

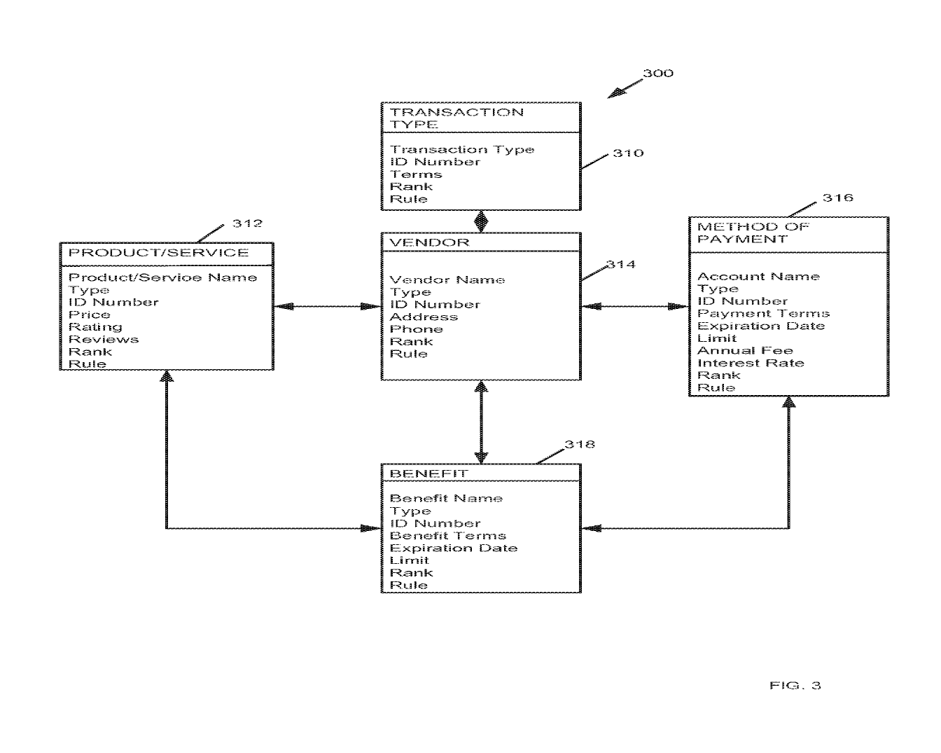

The finance advisor module 200 interfaces pith the policies database 214 to determine user-specified preferences or rules relating to one or more methods of payment, products, services, vendors, transaction types, or benefits associated with any of the foregoing. As an example, the user may prefer to use a certain credit card or bank account, generally or for certain types of electronic commerce transactions. As another example, the user have a preference for certain types of promotions or benefits (e.g. bundling of products and/or services, extended warranties, etc.) offered by products and/or services, vendors or method of payment vendors. As a further example, the user may have multiple coupons that could be applied to a given transaction, and may have a preference as to whether to use a coupon or reserve it for a later purchase. As yet another example, the user may have a particular goal in mind with respect to managing his or her finances, such as minimizing monthly expenses or avoiding carrying a balance on credit cards. Additional details relating to the policies database 214 are described below with reference to FIG. 3.

The financial impact analyzer module 216 is embodied as, computerized logic configured to provide the user with an analysis of the anticipated financial impact of the initiated electronic commerce transaction on the user's finances. In the illustrative embodiments, the financial impact analyzer module 216 is launchable by the financial advisor module 200 in response to user input (e.g. selection by the user of a “financial impact” button or touchscreen control on the mobile computing device 110). Some examples of analysis provided by the financial impact analyzer module 216 include the change to the user's regular (e.g., weekly, biweekly, monthly, etc.) expenses that would likely occur if the contemplated electronic commerce transaction were to be completed, and/or the change to the user's monthly payment or credit limit with respect to a particular credit card that would likely occur if the contemplated transaction were to completed. The financial impact analyzer module 216 calculates these values using information obtained from the finance data aggregator 160 and price and product/service information from the point of sale device 140, 146 involved in the transaction, as needed.

The method of payment analyzer module 218 is embodied as computerized logic configured to provide the user with a comparative analysis of multiple different methods of payment available to the user for use in the initiated electronic commerce transaction. In the illustrative embodiments, the method of payment analyzer module 218 is launchable by the financial advisor module 200 in response to user input (e.g., selection by the user of a “method of payment” button or touchscreen control on the mobile computing device 110). Some examples of analysis provided by the method of payment analyzer module 218 include a comparison of payment terms and/or benefits associated with the various methods of payment. For example, some methods of payment may give cash back on qualifying purchases. As another example, some methods of payment may have a lower interest rate than others. As a further example, the user may have defined a policy in the policies database 214 that identifies a particular method of payment as his or her preferred method of payment for a particular transaction or type of transaction. In providing its analysis, the method of payment analyzer module 218 accesses information obtained from the finance data aggregator 160, the policy database 214, and price and product/service information from the point of sale device 140, 146 involved in the transaction, as needed.

The transaction type analyzer module 220 is embodied as computerized logic configured to provide the user with a comparative analysis of multiple different transaction types available for use in the initiated electronic commerce transaction. In the illustrative embodiments, the transaction type analyzer module 220 is launchable by the financial advisor module 200 in response to user input (e.g., selection by the user of a “transaction type” button or touchscreen control on the mobile computing device 110). Some examples of analysis provided by the transaction type analyzer module 220 include a comparison of the payment terms if the desired product or service is purchased outright, versus jointly purchased by the use with other persons or versus using a loan, renting, leasing, using layaway, or other transaction types. For example, the transaction type analyzer 220 may analyze the available transaction type options and render a suggested transaction type to minimize the impact of the transaction on the user's monthly expenses. As a further example, the user may have defined a policy in the policy database 214 that identifies a particular transaction type as his or her preferred method of payment, or the user may have identified a policy in the policy database that establishes a rule that the transaction type should be selected in order to minimize the user's monthly payments. In providing its analysis, the transaction type analyzer module 220 accesses information obtained from the finance data aggregator 160, the policy database 214, and price and product/service information from the point of sale device 140, 146 involved in the transaction, as needed.

The product/service analyzer module 222 is embodied as computerized logic configured to provide the user with an analysis of the products and/or services that are the subject of the initiated electronic commerce transaction. In the illustrative embodiments, the products/service analyzer module 222 is launchable by the financial advisor module 200 in response to user input (e.g., selection by the user of a “product/service” button or touchscreen control on the mobile computing device 110). Some examples of analysis provided by the product/service analyzer module 222 include a comparison of the quality of the product or service to other similar products or services (e.g., brand name vs. store brand). For example, the product/service analyzer module 222 may analyze the available product or service options and render a suggested one of the products or services based on quality, reliability, or other information associated with the product or service that is the subject of the transaction. In some embodiments, the product/service analyzer module 222 may “crawl” the Internet, publicly available data feeds, or social networking sites for reviews, comments and/or ratings of the product or service that have been posted by friends of the user and/or others. As a further example, the user may have defined a policy in the policy database 214 that identifies a particular brand of product or service as his or her preferred brand, or the user may have identified a policy in the policy database that establishes a rule that a product or service should be ordered in bulk quantities. In providing its analysis, the product/service analyzer module 222 accesses information obtained from the finance data aggregator 160, the policy database 214, and price and product/service information from the point of sale device 140, 146 involved in the transaction, as needed.

The vendor analyzer module 224 is embodied as computerized logic configured to provide the user with an analysis of as vendor (e.g., a vendor of a product or service that is the subject of the transaction or a vendor of a method of payment) involved in the initiated electronic commerce transaction. In the illustrative embodiments, the vendor analyzer module 224 is launchable by the financial advisor module 200 in response to user input (e.g., selection by the user of a “vendor” button or touchscreen control on the mobile computing device 110). Some examples of analysis provided by the vendor analyzer module 224 include a comparison of the privacy practices, shipping policies, return policies, and/or other business policies of multiple vendor candidates, and/or vendor ratings issued by agencies such as Better Business Bureau and/or others. For example, the vendor analyzer module 224 may analyze the available vendor options and render a suggested one of the vendors based on responsiveness, reliability, location, or other information associated with the vendor of the product or service that is the subject of the transaction. In some embodiments, the vendor analyzer module 224 may “crawl” the Internet, publicly available data feeds, or social networking sites for reviews, comments and/or ratings of the vendor that have been posted by friends of the user and/or others. As a further example, the user may have defined a policy in the policy database 214 that identifies a particular vendor as his or her preferred vendor, or the user may have identified a policy in the policy database that establishes a rule that a vendor of a particular product type (e.g. fresh produce) should be local to the user. In providing its analysis, the vendor analyzer module 224 accesses information obtained from the finance data aggregator 160, the policy database 214, and price and product/service information from the point of sale device 140, 146 involved in the transaction, as needed.

The benefit analyzer module 226 is embodied as computerized logic configured to provide the user with an analysis of a benefit that is associated with a method of payment, transaction type, product or service, or vendor involved in the initiated electronic commerce transaction. In the illustrative embodiments, the benefit analyzer module 226 is launchable by the financial advisor module 200 in response to user input (e.g., selection by the user of a “benefits” button or touchscreen control on the mobile computing device 110). Some examples of analysis provided by the benefit analyzer module 226 include a comparison of the benefits offered by different payment methods (e.g., cash back, frequent flier miles, points, coupons, discounts, extended warranties, etc.). For example, the benefit analyzer module 226 may analyze the available benefits and render a suggested method of payment, transaction type, product or service, or vendor, based on the comparison of benefits. In some embodiments, the benefit analyzer module 226 may compare the benefits offered by competing vendors (e.g., buy one get one free, ninety days same as cash, 0% down, warranty terms, cost of extended warranties, etc.). As a further example, the user may have defined a policy in the policy database 214 that identifies a particular benefit as being of higher priority, or the user may have identified a policy in the policy database that establishes a rule that benefits are not to be considered in evaluating aspects of the transaction. In providing its analysis, the benefit analyzer module 226 accesses information obtained from the finance data aggregator 160, the policy database 214, and price and product/service information from the point of sale device 140, 146 involved in the transaction, as needed.

The finance/purchase data reporter module 228 is embodied as computerized logic configured to provide the user with a report of the user's current financial situation and/or purchase history. In the illustrative embodiments, the finance/purchase data reporter module 228 is launchable by the financial advisor module 200 in response to user input (e.g., selection by the user of a “finance/purchase data” button or touchscreen control on the mobile computing device 110). Some examples of information provided by the finance/purchase data reporter module 228 include the user's total expenses for the current month or a user-specified time period (e.g., weekly, biweekly, etc.), the user's income, deposits, or comparison of account activity or account balances for the current month or a user-specified time period, and/or others. As another example, the user may have defined a policy in the policy database 214 that identifies a particular type or format of report as being the user's preferred type or format, or the user may have identified a policy in the policy database that establishes a rule that a report should be automatically generated at the end of each month. In providing the financial and/or purchase history information, the finance/purchase data reporter module 228 accesses information obtained from the finance data aggregator 160, the policy database 214, and price and product/service information from the point of sale device 140, 146 involved in the transaction, as needed.

Referring now to FIG. 3, an illustrative data model 300 that may be used in connection with the policies database 214 is shown, including transaction type data 310, product/service data 312, vendor data 314, method of payment data 316, and benefit data 318. In general, the double-headed arrows connecting the various data types as shown in FIG. 3 indicate many-to-many relationships or associations among the data types, although one-to-one and/or one-to-many relationships are also possible in some embodiments. For example, a product or service 312 may be provided by any different vendors 314, and an individual vendor 314 may provide many different products or services 312. Similarly, a single vendor 314 may offer multiple methods of payment 316 (e.g., VISA, Mastercard, etc.), and a method of payment 316 may be offered by many different vendors. Likewise, a vendor 314 may be associated with multiple different transaction types 310 (e.g. a product or service vendor offering a credit card or cash transactions), and each transaction type 310 may be offered by many different vendors. Similarly, a benefit 318 can be offered by or associated with one or more products/services 312, vendors 314, and/or methods of payment 316 and many benefits can be offered by or associated with each product/service 312, vendor 314, and/or method of payment 316. To implement policies, each data type 310, 312, 314, 316, 318 includes a rank field and a rule field. The rank fields enable the user to specify preferred products/services 312, vendors 314, and/or methods of payment 316 by assigning a higher rank to those that are preferred by the user. For example, a preferred or “top of the wallet” method of payment may be assigned a rank value of 10, while other methods of payment may be assigned rank values that are less than 10. The rule fields enable the user to specify one or more rules associated with the transaction types 310, products/services 312, vendors 314, and/or methods of payment 316, or associate one or more of the data types with a rule. For example, a benefit 318 may have an expiration date, after which the benefit is no longer valid, and a rule associated therewith that specifies that it is okay to allow the benefit to expire unused. While described in the context of user-specified policies, in some embodiments, the policies database 214 can be used, alternatively or in addition, to track policies set by third parties. For example, rules may be configured to specify payment policies, return policies, shipment policies and/or others, associated with third parties such as product or services vendors or method of payment vendors.

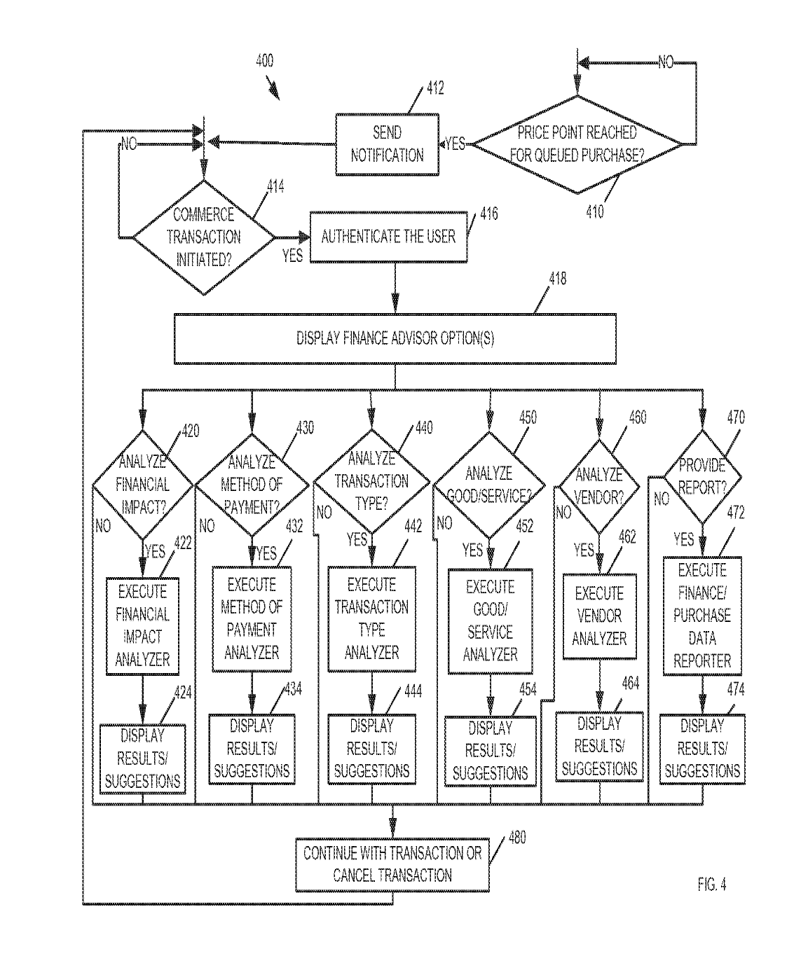

Referring now to FIG. 4, an illustrative method 400 executable by the purchase support system 130 is shown. Blocks 410 and 412 are associated with the queue module 212 discussed above. At block 410, the queue module 212 determines whether the price of a product or service has reached a price point established by the user as being a price at which the user would be willing to buy the product or service. If the user-specified price point has not been reached, the queue module 212 continues monitoring for the specified period of time, as discussed, above. If the price point has been reached, that is, at least one vendor is willing to sell the product or service at the user's price, then at block 412, the queue module 212 sends a notification to the user at the mobile computing device 110. If the user accepts the notification, the queue module 212 may then turn control over to the purchase tracker module 210 or directly to the finance advisor module 200 or to the vendor's point of sale device 140, 146.

At block 414, the purchase tracker module 210 determines whether an electronic commerce transaction has been initiated by the user at the mobile computing device 110 as described above. If the user has initiated an electronic commerce transaction, then at block 416 the user's identification and/or payment credentials 134 are authenticated or validated by the security engine 124, to verify that the user currently using the mobile computing device 110 is authorized to conduct the initiated electronic commerce transaction. At block 418, the finance advisor module 200 is launched, and the available analyses and/or reports are displayed to the user on a display screen of the mobile computing device 110 as selectable options. The particular options displayed may vary depending on the requirements of a given implementation of the purchase support system 130, constraints of the mobile computing device 110, and/or other factors. For example, in some embodiments, only the financial impact analyzer 216 may be available, while in other embodiments, the system 130 may be configurable to allow the user to determine which of the available options are displayed at the computing device 110.

At blocks 420, 430, 440, 450, 460, 470, respectively, a determination is made as to whether an option (e.g., financial impact, method of payment, transaction type, product service, vendor, report) is selected by the user (e.g. via a check box, radio button, microphone or other input device coupled to the computing device 110). If an option is selected by the user, then, as described above, the corresponding analyzer 216, 218, 220, 222, 224, 226 is executed at block 422, 432, 442, 452, 462, 472, as the case may be. If none of the options are selected, the method 400 proceeds to block 480, where the electronic commerce transaction may continue without having executed the features of the finance advisor module 200.

Following execution of a selected analyzer at one or more of blocks 422, 432, 442, 452, 462, 472, the results of the analysis performed by the respective analyzer 216, 218, 220, 222, 224, 226, which may include one or more suggestions or recommendations, or reports generated by the reporter 228, as the case may be, are displayed at the mobile computing device 110, at the corresponding block 424, 434, 444, 454, 464, 474. At block 480, the user can decide whether to continue with the electronic commerce transaction or cancel the transaction. In either case. i.e., once the transaction is either canceled or completed, the method 400 returns to block 414.

While the disclosure has been illustrated and described in detail in the drawings and foregoing description, such an illustration and description is to be considered as exemplary and not restrictive in character, it being understood that only illustrative embodiments have been shown and described and that all changes and modifications that conic within the spirit of the disclosure are desired to be protected. Further, while aspects of the present disclosure have been described in the context of a mobile commerce system, it will be understood that the various aspects have other applications, for example, in desktop or other non-portable computing devices, and in any electronic commerce application in which it may be desirable to analyze a users finance-related information prior to, during, or after completion of a contemplated electronic commerce transaction.

1-20. (canceled)

21. At least one computer accessible medium comprising a plurality of instructions that in response to being executed cause a computing device to:
detect initiation of an electronic data transaction by a user; and
execute, in response to the detection of the initiation of the electronic data transaction, an advisor application to:
(i) provide impact data indicative of a change to a regular schedule of electronic data transactions of the user that would result if the initiated electronic data transaction were completed;
(ii) receive an input responsive to the provided impact data, wherein the input responsive to the provided impact data indicates to discontinue the initiated electronic data transaction or to continue the initiated electronic data transaction;
(iii) discontinue the initiated electronic data transaction in response to the input responsive to the provided impact data indicating to discontinue the initiated electronic data transaction; and
(iv) continue the initiated electronic data transaction in response to the input responsive to the provided impact data indicating to continue the initiated electronic data transaction.

22. The at least one computer accessible medium of claim 21, wherein the plurality of instructions, when executed, further cause the computing device to display, at the computing device, during the electronic data transaction, information relating to the impact data.

23. The at least one computer accessible medium of claim 21, wherein the plurality of instructions, when executed, further cause the computing device to provide analysis relating to at least one benefit associated with the electronic data transaction and display, at the computing device, during the electronic data transaction, information relating to the at least one benefit.

24. The at least one computer accessible medium of claim 21, wherein the plurality of instructions, when executed, further cause the computing device to provide analysis relating to at least one electronic data transaction type associated with the electronic data transaction and display, at the computing device, during the electronic data transaction, information relating to the at least one electronic data transaction type.

25. The at least one computer accessible medium of claim 21, wherein the plurality of instructions, when executed, further cause the computing device to communicate with at least one second computing device over a network to obtain the regular schedule of electronic data transactions of the user.

26. The at least one computer accessible medium of claim 21, wherein the plurality of instructions, when executed, further cause the computing device to execute the advisor application prior to completion of the electronic data transaction.

27. The at least one computer accessible medium of claim 21, wherein the plurality of instructions, when executed, further cause the computing device to access preference information specified by the user and using the preference information in the analysis relating to the change of the regular schedule of electronic data transactions of the user in relation to the initiated electronic data transaction.

28. The at least one computer accessible medium of claim 21, wherein the plurality of instructions, when executed, further cause the computing device to display the analysis of the advisor application at a mobile computing device.

29. The at least one computer accessible medium of claim 21, wherein the plurality of instructions, when executed, further cause the computing device to monitor the user's electronic data transactions conducted over a period of time and generate an alert in response to one or more electronic data transactions conducted over a period of time and generate an alert in response to one or more electronic data transactions being determined to be inconsistent with the user's electronic data transactions conducted over a period of time.

30. A computing device comprising:
at least one processor; and
computer circuitry coupled to the at least one processor, the computer circuitry being arranged to cause the at least one processor to:
detect initiation of an electronic data transaction by a user; and
execute, in response to detection of the initiation of the electronic data transaction, an advisor application to:
(i) provide impact data indicative of a change to a regular schedule of electronic data transactions of the user that would result if the initiated electronic data transaction were completed;
(ii) receive an input responsive to the provided impact data, wherein the input responsive to the provided impact data indicates to discontinue the initiated electronic data transaction or to continue the initiated electronic data transaction;
(iii) discontinue the initiated electronic data transaction in response to the input responsive to the provided impact data indicating to discontinue the initiated electronic data transaction; and
(iv) continue the initiated electronic data transaction in response to the input responsive to the provided impact data indicating to continue the initiated electronic data transaction.

31. The computing device of claim 30, wherein the computer circuitry is arranged to further cause the at least one processor to display, at the computing device, during the electronic data transaction, information relating to the impact data.

32. The computing device of claim 30, wherein the computer circuitry is arranged to further cause the at least one processor to provide analysis relating to at least one benefit associated with the electronic data transaction and display, at the computing device, during the electronic data transaction, information relating to the at least one benefit.

33. The computing device of claim 30, wherein the computer circuitry is arranged to further cause the at least one processor to provide analysis relating to at least one electronic data transaction type associated with the electronic data transaction and display, at the computing device, during the electronic data transaction, information relating to the at least one electronic data transaction type.

34. The computing device of claim 30, wherein the computer circuitry is arranged to further cause the at least one processor to communicate with at least one second computing device over a network to obtain the regular schedule of electronic data transactions of the user.

35. The computing device of claim 30, wherein the computer circuitry is arranged to further cause the at least one processor to execute the advisor application prior to completion of the electronic data transaction.

36. The computing device of claim 30, wherein the computer circuitry is arranged to further cause the at least one processor to access preference information specified by the user and using the preference information in the analysis relating to the change of the regular schedule of electronic data transactions of the user in relation to the initiated electronic data transaction.

37. The computing device of claim 30, wherein the computer circuitry is arranged to further cause the at least one processor to display the analysis of the advisor application at a mobile computing device.

38. The computing device of claim 30, wherein the computer circuitry is arranged to further cause the at least one processor to monitor the user's electronic data transactions conducted over a period of time and generate an alert in response to one or more electronic data transactions conducted over a period of time and generate an alert in response to one or more electronic data transactions being determined to be inconsistent with the user's electronic data transactions conducted over a period of time.

39. A computing device comprising:
at least one processor; and
computer circuitry coupled to the at least one processor, the computer circuitry being arranged to cause the at least one processor to:
initiate an electronic data transaction with a device different from the computing device in response to an input by a user, and
automatically display, during the electronic data transaction, information indicative of an anticipated change to a regular schedule of electronic data transactions of the user that would result if the initiated electronic data transaction were completed.

40. The computing device of claim 39, arranged to monitor the user's electronic data transactions conducted over a period of time and generate an alert in response to one or more electronic data transactions being determined to be inconsistent with the user's electronic data transactions conducted over a period of time.
